(19) United States
(12) Patent Application Publication
(10) Pub. No.: US 2026/0333240 A1
(43) Pub. Date: Oct. 22, 2026

(54) POWER SPECTRAL DENSITY BASED MAXIMUM OUTPUT POWER SELECTION

(71) Applicant: Lenovo (United States) Inc., Morrisville, NC (US)

(72) Inventor: Colin Frank, Park Ridge, IL (US)

(73) Assignee: Lenovo (United States) Inc., Morrisville, NC (US)

(21) Appl. No.: 19/344,059

(22) Filed: Sep. 29, 2025

(51) Int. Cl. H04W 52/14; H04L 5/00; H04W 52/36

(52) U.S. Cl. CPC H04W 52/146; H04L 5/0005; H04W 52/367

(57) ABSTRACT

Various aspects of the present disclosure relate to power spectral density (PSD) based maximum output power selection. A user equipment (UE) may receive signaling from a network equipment (NE) that indicates a time-frequency resource allocation for an uplink transmission. The UE may select a maximum output power for the uplink transmission that satisfies a threshold PSD associated with the time-frequency resource allocation. For example, the UE may determine a maximum output power based on an upper bound for the maximum output power and a lower bound for the maximum output power that satisfy at least the threshold PSD. The UE may transmit the uplink transmission using a power that is less than or equal to the maximum output power.

### TECHNICAL FIELD

The present disclosure relates to wireless communications, and more specifically to power control for wireless transmissions.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive signaling that indicates a time-frequency resource allocation associated with an uplink transmission, select a maximum output power (e.g., a configured maximum output power) for the uplink transmission, where the maximum output power satisfies a threshold power spectral density (PSD) associated with the time-frequency resource allocation, and transmit the uplink transmission using a power that is based at least in part on the maximum output power (e.g., less than or equal to the maximum output power).

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a time-frequency resource allocation associated with an uplink transmission, select a maximum output power for the uplink transmission, where the maximum output power satisfies a threshold PSD associated with the time-frequency resource allocation, and transmit the uplink transmission using a power that is based at least in part on the maximum output power.

A method performed or performable by a UE for wireless communication is described. The method may include receiving signaling that indicates a time-frequency resource allocation associated with an uplink transmission, selecting a maximum output power for the uplink transmission, where the maximum output power satisfies a threshold PSD associated with the time-frequency resource allocation, and transmitting the uplink transmission using a power that is based at least in part on the maximum output power.

In some implementations of the UE, the processor, and the method described herein, to select the maximum output power, the UE, the processor, and the method may further be configured to, capable of, or operable to determine an upper bound for the maximum output power, where the upper bound is based on one or more of a resource block (RB) allocation associated with the time-frequency resource allocation, a subcarrier spacing (SCS) associated with the time-frequency resource allocation, a bandwidth of a carrier associated with the uplink transmission, or an additional maximum power associated with the threshold PSD. In some implementations of the UE, the processor, and the method described herein, to satisfy the threshold PSD associated with the time-frequency resource allocation, the maximum output power is less than the upper bound. In some implementations of the UE, the processor, and the method described herein, the UE, the processor, and the method may further be configured to, capable of, or operable to determine the maximum output power associated with the uplink transmission based on a difference between a maximum output power capability of a power class associated with the UE and an additional maximum output power associated with the threshold PSD.

In some implementations of the UE, the processor, and the method described herein, to select the maximum output power, the UE, the processor, and the method may further be configured to, capable of, or operable to determine a lower bound for the maximum output power. In some implementations of the UE, the processor, and the method described herein, to satisfy the threshold PSD associated with the time-frequency resource allocation, the maximum output power is greater than the lower bound. In some implementations, the UE, the processor, and the method may further be configured to, capable of, or operable to determine the maximum output power based on one or more of a bandwidth of a carrier associated with the uplink transmission or a difference between a maximum output power capability of a power class associated with the UE and an additional maximum output power associated with the threshold PSD. In some implementations, the UE, the processor, and the method may further be configured to, capable of, or operable to receive additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD value different from the first maximum PSD and the second maximum PSD, or an indication that there is no maximum PSD.

An NE (e.g., a base station) for wireless communication is described. The NE may be configured to, capable of, or operable to perform one or more operations as described herein. For example, the NE may be configured to, capable of, or operable to transmit signaling that indicates a time-frequency resource allocation associated with an uplink transmission, where the uplink transmission is associated with a maximum output power that satisfies a threshold PSD associated with the time-frequency resource allocation and receive the uplink transmission associated with a power that is based on the maximum output power.

A processor (e.g., a standalone processor chipset, or a component of an NE) for wireless communication is described. The processor may be configured to, capable of, or operable to perform one or more operations as described herein. For example, the processor may be configured to, capable of, or operable to transmit signaling that indicates a time-frequency resource allocation associated with an uplink transmission, where the uplink transmission is associated with a maximum output power that satisfies a threshold PSD associated with the time-frequency resource allocation and receive the uplink transmission associated with a power that is based on the maximum output power.

A method performed or performable by an NE (e.g., a base station) for wireless communication is described. The method may include transmitting signaling that indicates a time-frequency resource allocation associated with an uplink transmission, where the uplink transmission is associated with a maximum output power that satisfies a threshold PSD associated with the time-frequency resource allocation and receiving the uplink transmission associated with a power that is based on the maximum output power.

In some implementations of the NE, the processor, and the method described herein, the maximum output power is less than an upper bound for the maximum output power, wherein the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. In some implementations, the maximum output power is based on a difference between a maximum output power capability of a power class associated with a UE and an additional maximum output power associated with the threshold PSD.

In some implementations, the maximum output power is greater than a lower bound for the maximum output power. In some implementations, the maximum output power is based on one or more of a bandwidth of a carrier associated with the uplink transmission or a difference between a maximum output power capability of a power class associated with a UE and an additional maximum output power associated with the threshold PSD. In some implementations, the NE, the processor, and the method may further be configured to, capable of, or operable to transmit additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD value different from the first maximum PSD and the second maximum PSD, or an indication that there is no maximum PSD.

### BRIEF DESCRIPTION OF THE DRAWINGS

FIGS. 1 and 2 illustrate examples of wireless communications systems in accordance with aspects of the present disclosure.

FIGS. 3 and 4 illustrate examples of transmission diagrams, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. For example, the wireless communications system may operate across various frequency bands and support different transmission bandwidths. A UE and/or an NE in the wireless communications system may manage output powers for transmissions to enable efficient spectrum utilization, reduce interference between devices in the wireless communications system, and comply with regulatory criterion. For example, a UE may select a power for a transmission that accounts for path loss measurements, power control commands from an NE, and one or more defined or configured maximum output power values, among other factors. The selected power may be less than a maximum total output power value, which represents an absolute maximum power the device can output regardless of the allocated bandwidth. Additionally, or alternatively, the wireless communications system may implement a threshold PSD that results in a maximum output power per unit bandwidth for some bandwidths. The threshold PSD may be in units of decibel milliwatts (dBm) per RB or dBm per megahertz (MHz).

However, the coexistence of both a maximum total output power and a threshold PSD increases the complexity of power selection, as the UE may determine whether the maximum total output power or a maximum output power that satisfies the threshold PSD is more restrictive for a given bandwidth allocation. For relatively wide bandwidth transmissions (e.g., greater than a threshold bandwidth), the maximum total output power may be an upper bound for a maximum output power for the wide bandwidth transmissions. For relatively narrow bandwidth transmissions (e.g., less than a threshold bandwidth), the maximum output power that satisfies the threshold PSD may be the upper bound for the maximum output power, preventing the UE from utilizing a full output power capability even if the maximum total output power has not been reached. The presence of the maximum total output power and the maximum output power related to the threshold PSD can lead to inefficient power utilization, where the UE either underutilizes an available output power or implements complex power selections. Additionally, or alternatively, the UE may not adequately account for dynamic bandwidth allocations and varying channel conditions, potentially resulting in inefficient power allocation that degrades link performance and overall throughput in the wireless communications system.

As described herein, to improve output power efficiency and simplify power control procedures, a UE may dynamically select a maximum output power for an uplink transmission according to an upper bound and/or a lower bound that accounts for a threshold PSD of a time-frequency resource allocation. For example, the UE may receive signaling from an NE that indicates the time-frequency resource allocation for the uplink transmission and may determine a maximum output power that satisfies the threshold PSD. The UE may calculate an upper bound of the maximum output power utilizing one or more parameters, including an RB allocation, an SCS, a bandwidth of a carrier, or a maximum power for the uplink transmission (e.g., a maximum total transmit power). In some cases, the UE may determine a lower bound for the maximum output power by calculating a difference between a maximum output power capability of a power class of the UE and a maximum output power that satisfies the threshold PSD. The UE may select the maximum output power for the uplink transmission to be within the upper and lower bounds, and may transmit the uplink transmission using a power that is less than or equal to the selected maximum output power.

By performing the described techniques, one or more devices (e.g., UEs and NEs) in a wireless communications system select a maximum output power to satisfy a threshold PSD of a time-frequency resource allocation. For example, a UE selecting a maximum output power according to the threshold PSD improves power utilization efficiency by eliminating or reducing selection between a conflicting maximum total output power and a maximum output power that satisfies the PSD threshold. Additionally, or alternatively, the UE selecting the maximum output power according to the threshold PSD reduces computational complexity in power control procedures by providing a unified framework that adapts dynamically to resource allocations. Additionally, or alternatively, the UE selecting the maximum output power according to the threshold PSD enhances link performance across varying bandwidth allocations by enabling power distributions that maintain regulatory compliance and maximize throughput.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

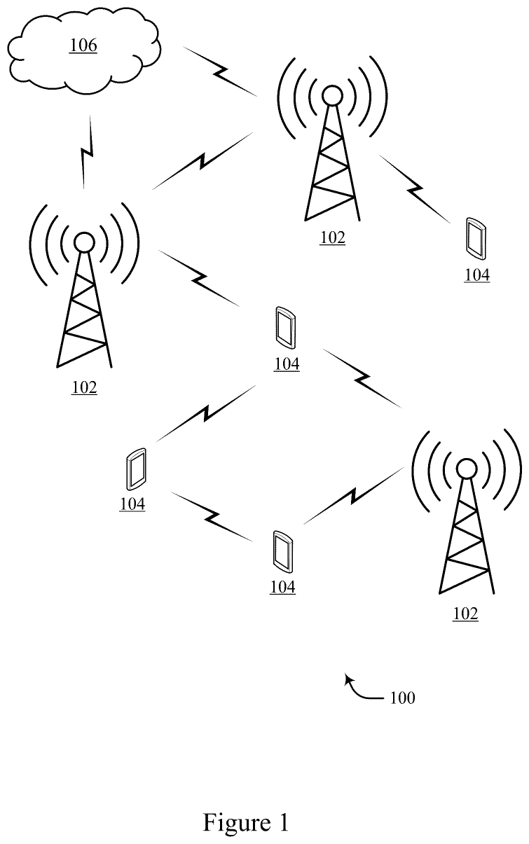

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include an SCS and a cyclic prefix. A first numerology (e.g., μ=0) may be associated with a first SCS (e.g., 15 kHz) and a normal cyclic prefix. In some implementations, the first numerology (e.g., μ=0) associated with the first SCS (e.g., 15 kHz) may utilize one slot per subframe. A second numerology (e.g., μ=1) may be associated with a second SCS (e.g., 30 kHz) and a normal cyclic prefix. A third numerology (e.g., μ=2) may be associated with a third SCS (e.g., 60 kHz) and a normal cyclic prefix or an extended cyclic prefix. A fourth numerology (e.g., μ=3) may be associated with a fourth SCS (e.g., 120 kHz) and a normal cyclic prefix. A fifth numerology (e.g., μ=4) may be associated with a fifth SCS (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 gigahertz (GHz)), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

In the wireless communications system 100, the NEs 102 and the UEs 104 may manage output powers for wireless transmissions. An output power may refer to the amount of radio frequency energy output by a transmitting device, which may also be referred to as transmission power, transmit power, or radiated power. In some cases, the NEs 102 and/or the UEs 104 may dynamically adjust an output power to match channel conditions and resource allocations. Channel conditions may include a quality and characteristics of a wireless communication path between devices (e.g., the NE 102 and the UE 104), including path loss, fading, interference levels, and signal-to-noise ratio (SNR). The NE 102 and/or the UE 104 may adjust transmit power by increasing output power levels to compensate if channel conditions are below a threshold value or reducing output power levels if channel conditions exceed a threshold value. The NE 102 may allocate one or more time-frequency resources, such as frequency bands, time slots, and/or RBs, to a UE 104 for transmission. The NE 102 and/or the UE 104 may adjust an output power based on a bandwidth or number of RBs allocated for transmission to maintain spectral efficiency and regulatory compliance. Adjusting output power based on channel conditions and resource allocations may provide for multiple devices (e.g., NEs 102 and/or UEs 104) to share one or more of the same frequency bands without inefficient output power or unnecessary spectral emissions that impact a capacity of neighboring channels.

Additionally, or alternatively, the NEs 102 and/or the UEs 104 may adjust an output power to minimize signal interference in adjacent frequency bands or geographic areas, which prevents or reduces a transmission from degrading a signal quality and data throughput of other devices operating in a same or nearby frequency band or geographic area. Additionally, or alternatively, the NEs 102 and/or the UEs 104 may maintain an output power within one or more defined maximums or limits (e.g., defined by regulatory authorities), such as PSD thresholds or maximums and a maximum total output power, which prevents or reduces interference to other wireless services and protects public safety communications operating in adjacent or overlapping frequency bands. In some cases, wireless communications system 100 may implement PSD thresholds that define a maximum output power per unit bandwidth.

In some examples, a UE 104 may determine a power for uplink transmissions based on various factors, including path loss measurements between the UE 104 and an NE 102, power control commands received from the NE 102, and/or one or more maximum output power values that may be defined by regulatory authorities or configured by one or more NEs 102. Path loss may refer to the reduction in power density of an electromagnetic wave as the electromagnetic wave propagates through space from a transmitter to a receiver, which may be caused by distance, obstacles, atmospheric conditions, and/or multipath propagation, among other factors. The power selection may account for multiple different parameters, such as ensuring a sufficient signal quality at the NE 102 (e.g., greater than a threshold signal quality), while reducing or avoiding excessive interference to other devices in the wireless communications system 100. In some cases, the UE 104 may select a power that is less than a maximum total output power, which represents an absolute maximum power the UE 104 can output regardless of an allocated bandwidth. For example, the power of UEs 104 operating in a defined frequency band (e.g., the 4940 through 4990 MHz band) may not exceed the maximum output power defined in Table 1 for base, mobile, and temporary fixed operations.

TABLE 1
Maximum conducted output power

| | Low power maximum | High power maximum |
|---|---|---|
| Channel bandwidth | conducted output power | conducted output power |
| (MHz) | (dBm) | (dBm) |
| 1 | 7 | 20 |
| 5 | 14 | 27 |
| 10 | 17 | 30 |
| 15 | 18.8 | 31.8 |
| 20 | 20 | 33 |
| 30 | 21.8 | 34.8 |
| 40 | 23 | 36 |
| 50 | 24 | 37 |

Devices that are capable of transmitting using a power that exceeds a threshold value may be referred to as high power devices. The high power devices may be limited to a maximum (e.g., peak) PSD value, such as 21 dBm per one MHz. For example, high power devices using channel bandwidths other than the channel bandwidths listed in Table 1 may be limited to the maximum PSD value. If the high power devices utilize transmitting antennas with a directional gain greater than a threshold value, such as 9 dB (isotropic) (dBi), then both a maximum conducted output power and the maximum PSD are reduced by the amount in decibels that the directional gain of the antenna exceeds the threshold value. However, high power point-to-point and point-to-multipoint operations (e.g., both fixed and temporary-fixed rapid deployment) may employ transmitting antennas with directional gain that exceeds the threshold value (e.g., up to 26 dBi) without any corresponding reduction in the maximum conducted output power or maximum PSD. Corresponding reduction in the maximum conducted output power and maximum PSD is the amount in decibels that the directional gain of the antenna exceeds the directional gain (e.g., the 26 dBi).

Devices that are capable of transmitting using a power that is less than a threshold value may be referred to as low power devices. Low power devices are also limited to a maximum PSD value, such as 8 dBm per one MHz. For example, low power devices using channel bandwidths other than those listed in Table 1 may be limited to the maximum PSD value. If the low power devices utilize transmitting antennas with a directional gain greater than a threshold value, such as 9 dBi, then both the maximum conducted output power and the maximum PSD are reduced by the amount in decibels that the directional gain of the antenna exceeds the threshold value. The maximum conducted output power is measured as a conducted emission over any interval of continuous transmission using instrumentation calibrated in terms of a root mean square (RMS) equivalent voltage. If the device cannot be connected directly, then alternative techniques may be used. The measurement results may be adjusted for any instrument limitations, such as detector response times, limited resolution bandwidth capability when compared to the emission bandwidth, sensitivity, etc., so as to obtain a true maximum conducted output power measurement. The maximum PSD is measured as conducted emission by direct connection of a calibrated test instrument to the equipment under test. If the device cannot be connected directly, then alternative techniques may be used. Measurements are made over a bandwidth of one MHz or a defined emission bandwidth of the device (e.g., 26 dB), whichever is less. A resolution bandwidth less than the measurement bandwidth can be used, provided that the measured power is integrated to show total power over the measurement bandwidth. If the resolution bandwidth is approximately equal to the measurement bandwidth, and much less than the emission bandwidth of the equipment under test, then the measured results are corrected to account for any difference between the resolution bandwidth of the test instrument and an actual noise bandwidth.

In some cases, a ratio of the peak excursion of a modulation envelope (e.g., measured using a peak hold function) to the maximum conducted output power may not exceed a threshold value (e.g., 13 dB across any 1 MHz bandwidth) or the emission bandwidth, whichever is less. The transmit power of permanent fixed point-to-point and point-to-multipoint UEs or stations operating in the 4940 through 4990 MHz band must not exceed a threshold value. The maximum equivalent isotropically radiated power (EIRP), as referenced to an isotropic radiator, may not exceed a defined value (e.g., 55 dBWatts (dBW) or 85 dBm). For path lengths shorter than a threshold value, 17 kilometers, the EIRP may not exceed the value derived from Equation 1:

$$New EIRP limit = 55 dBW - 40 * log ( \frac{17}{B} ) dBW , \qquad ( 1 )$$

where B is the actual path length in kilometers.

The UE may set (e.g., define, select, determine, identify) a configured maximum output power, P_{CMAX,f,c}, for a carrier, f, of a serving cell, c, in each slot. The configured maximum output power P_{CMAX,f,c} is set within bounds, P_{CMAX_L,f,c}≤P_{CMAX,f,c}≤P_{CMAX_H,f,c}, according to Equation 2 and Equation 3:

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad ( 2 )$$

$${P}_{CMAX \_ H , f , c} = MIN \{ {P}_{EMAX , c} , {P}_{PowerClass} - Δ {P}_{PowerClass} \} , \qquad ( 3 )$$

where P_{EMAX,c} is the value given by either a p-Max information element (IE) or a field additionalPmax of the NR-NS-PmaxList IE. P_{PowerClass} is a maximum UE power defined for shared spectrum access operation, without taking into account a tolerance defined for the shared spectrum access operation. If the IE powerBoostPi2BPSK is set to 1, then P_{EMAX,c} is increased by 3 dB for a power class 3 UE operating in time division duplex (TDD) bands n40, n41, n77, n78, and n79 with PI/2 binary phase-shift keying (BPSK) modulation with a demodulation reference signal (DMRS), and if a UE 104 indicates support for UE capability powerBoosting-pi2BPSK and 40% or less symbols in certain evaluation period are used for uplink transmission if P_{EMAX,c} is greater than or equal to 20 dBm (e.g., the exact evaluation period is no less than one radio frame). If the IE powerBoostPi2BPSK is set to 1, then ΔP_{PowerClass} is equal to −3 dB for a power class 3 UE operating in TDD bands n40, n41, n77, n78, and n79 with Pi/2 BPSK modulation with a DMRS and if a UE 104 indicates support for UE capability powerBoosting-pi2BPSK and 40% or less slots in radio frame are used for uplink transmission.

In some cases, ΔP_{PowerClass} is equal to 3 dB for a power class 2 UE or 6 dB for a power class 1.5 UE if P-max of 23 dBm or lower is indicated. Additionally, or alternatively, ΔP_{PowerClass} is equal to 3 dB for a power class 2 UE or 6 dB for a power class 1.5 UE if the field of UE capability maxUplinkDutyCycle-PC2-FR1 is absent and the field of UE capability maxUplinkDutyCycle-PC1dot5-MPE-FR1 is absent and the percentage of uplink symbols transmitted in a defined evaluation period is larger than 50%. Additionally, or alternatively, ΔP_{PowerClass} is equal to 3 dB for a power class 2 UE or 6 dB for a power class 1.5 UE if the field of UE capability maxUplinkDutyCycle-PC2-FR1 is not absent and the percentage of uplink symbols transmitted in a defined evaluation period is larger than maxUplinkDutyCycle-PC2-FR1 (e.g., the exact evaluation period is no less than one radio frame). Additionally, or alternatively, ΔP_{PowerClass} is equal to 3 dB for a power class 2 UE or 6 dB for a power class 1.5 UE if the field of UE capability maxUplinkDutyCycle-PC1dot5-MPE-FR1 is not absent and half the percentage of uplink symbols transmitted in a defined evaluation period is larger than maxUplinkDutyCycle-PC1dot5-MPE-FR1 (e.g., the exact evaluation period is no less than one radio frame).

In some cases, ΔP_{PowerClass} is equal to 3 dB for a power class 1.5 UE if P-max is between 23 dBm and 26 dB. Additionally, or alternatively, ΔP_{PowerClass} is equal to 3 dB if the field of UE capability maxUplinkDutyCycle-PC2-FR1 is absent and the field of UE capability maxUplinkDutyCycle-PC1dot5-MPE-FR1 is absent and the percentage of uplink symbols transmitted in a defined evaluation period is between 25% and 50%. Additionally, or alternatively, ΔP_{PowerClass} is equal to 3 dB if the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2 (e.g., the exact evaluation period is no less than one radio frame). Additionally, or alternatively, ΔP_{PowerClass} is equal to 3 dB if the field of UE capability maxUplinkDutyCycle-PC1dot5-MPE-FR1 is not absent and the percentage of uplink symbols transmitted in a defined evaluation period is larger than maxUplinkDutyCycle-PC1dot5-MPE-FR1 (e.g., the exact evaluation period is no less than one radio frame).

Additionally, or alternatively, ΔP_{PowerClass} is equal to 3 dB if the UE is configured with supplementary uplink (SUL) configurations and the criterion of default power class are applied on the band where UE indicates power class 2. Additionally, or alternatively, a ΔP_{PowerClass} of 3 dB is applied during sounding reference signal (SRS) transmission occasions with usage in SRS-ResourceSet set as ‘antennaSwitching’ with configured SRS resources in each SRS resource set including one SRS port if a PC2 UE with txDiversity-r16 capability or PC1.5 UE further indicates SRS-TxSwitch capability ‘t1r2’ or ‘t1r4’ or ‘t1r1-t1r2’ or ‘t1r1-t1r2-t1r4’. The ΔP_{PowerClass} is equal to 0 dB otherwise.

In some cases, ΔT_{IB,c} is the additional tolerance for serving cell, c, as defined for NR carrier aggregation (CA), for SUL, or for evolved universal mobile telecommunications system (UMTS) terrestrial radio access (E-UTRA)-NR dual connectivity (DC) (EN-DC). For other cases, ΔT_{IB,c} is equal to 0 dB. If the UE supports more than one band combination for V2X operating bands for concurrent operation, CA, SUL or DC, and an operating band belongs to more than one band combination, and if the operating band frequency range is less than or equal to one GHz, then the applicable additional ΔT_{IB,c} may be the average value for all defined band combinations, truncated to one decimal place that apply for that operating band among the supported band combinations. If there is a harmonic relation between low band uplink and high band downlink, then the maximum ΔT_{IB,c} among the different supported band combinations involving such band is applied. If the UE supports more than one band combination for V2X operating bands for concurrent operation, CA, SUL or DC, and an operating band belongs to more than one band combination, and if the operating band frequency range is greater than one GHz, then the applicable additional ΔT_{IB,c} may be the maximum value for all defined band combinations for the applicable operating bands. In some cases, ΔT_{C,c} is equal to 1.5 dB when one or more conditions for a serving cell, c, are met and is equal to 0 dB otherwise.

A maximum power reduction for a serving cell, c, and an additional maximum power reduction for the serving cell, c, A-MPR_{c} are power reduction values applied to limit transmit power based on modulation schemes and transmission configurations to ensure compliance with spectral emission thresholds and adjacent channel interference limits. In some cases, ΔMPR_{c} for the serving cell, c, is an additional power reduction value applied under one or more transmission conditions to maintain signal quality and regulatory compliance. A delta tolerance for SRS reception, ΔT_{RxSRS} ( ) is applied during SRS transmission occasions when the SRS resource set usage is configured for antenna switching operations, where SRSs are uplink reference signals used for channel quality measurement and antenna selection. In some cases, the UE transmits an SRS on the second SRS resource in every configured SRS resource set when the SRS transmission switching capability supports one transmit antenna and two receive antennas (t1r2) or supports both single antenna and dual antenna configurations (t1r1-t1r2). Additionally, or alternatively, the UE transmits an SRS on the second, third, and fourth SRS resources of the total four SRS resources from all configured SRS resource sets including one SRS port when the SRS transmission switching capability supports various antenna configurations including one transmit with four receive antennas (t1r4), two transmit with four receive antennas (t1r4-t2r4), or multiple antenna switching combinations. Additionally, or alternatively, the UE transmits an SRS from the SRS port pair on the second SRS resource in every configured SRS resource set including two SRS ports when the SRS transmission switching capability supports two transmit antennas with four receive antennas (t2r4) or various multi-antenna configurations. Additionally, or alternatively, the UE transmits an SRS to a downlink-only carrier, which is a frequency carrier designated exclusively for downlink transmissions from the network to the UE.

In some examples, the value of ΔT_{RxSRS} is 4.5 dB for frequency bands with an upper uplink frequency (F_{UL_high}) that is higher than the lower uplink frequency of band n79 and 3 dB for bands with an upper uplink frequency that is lower than the lower uplink frequency of band n79 when the device operates as power class 3, power class 5, power class 1.5, or power class 2 with a 3 dB power class reduction, or when the UE supports transmit diversity capabilities. The value of ΔT_{RxSRS} is 7.5 dB for frequency bands with an upper uplink frequency that is higher than the lower uplink frequency of band n79 and 6 dB for bands with an upper uplink frequency that is lower than the lower uplink frequency of band n79 during SRS transmission occasions with configured SRS resources consisting of one SRS port when the device is power class 2 with no power class reduction (ΔP_{PowerClass}=0 dB) and does not support transmit diversity. For all other SRS transmissions not meeting the above conditions, ΔT_{RxSRS} is zero.

A power management maximum power reduction for a serving cell, c, P-MPR_{c}, is a power reduction applied to ensure compliance with regulatory criterion and address interference issues in one or more operational scenarios. For example, P-MPR_{c} is the power management maximum power reduction for ensuring compliance with applicable electromagnetic energy absorption requirements (such as Specific Absorption Rate limits) and addressing unwanted emissions or self-desensitization requirements when the UE simultaneously transmits on multiple radio access technologies. Additionally, or alternatively, P-MPR_{c} is the power management maximum power reduction for ensuring compliance with applicable electromagnetic energy absorption thresholds when proximity detection systems are used to detect nearby objects or human presence, resulting in reduced maximum output power for safety. In some cases, the UE may apply P-MPR_{c} for the serving cell, c, for the above specified cases. For UE conducted conformance testing, P-MPR_{c} is 0 dB, meaning no power reduction is applied during standardized testing procedures. P-MPR_{c} was introduced in the P_{CMAX,f,c} equation to enable a UE 104 to report the available maximum output transmit power to the NE 102. This information can be used by the NE 102 for scheduling decisions and resource allocation. P-MPR_{c} may impact the maximum uplink performance for the selected uplink transmission path by reducing the available output power and potentially affecting data throughput and coverage.

The wireless communications system 100 may implement multiple power classes for UEs 104 operating in defined frequency bands, such as the 4940 through 4990 MHz band used for public safety operations. Power classes define a maximum transmit power capability of a UE 104, with higher power classes enabling greater transmit power levels. For example, power class 3 (PC 3) UEs may have a maximum transmit power capability of 23 dBm, power class 2 (PC 2) UEs may support up to 26 dBm, power class 1.5 (PC 1.5) UEs may support up to 29 dBm, and power class 1 (PC 1) UEs may support up to 31 dBm. The power classes enable different types of devices (e.g., different types of UEs 104, stations, or other devices) to operate with output power levels based on intended use cases and regulatory criterion.

The regulatory framework for one or more frequency bands, such as the 4940 through 4990 MHz band, establishes two distinct maximum output powers (e.g., thresholds, limitations, limits) that are enforced independently. The first maximum output power is a maximum conducted power as a function of channel bandwidth, with different limits or thresholds for low power devices and high power devices, as shown in Table 1. For high power devices, the maximum conducted power ranges from 20 dBm for 1 MHz bandwidth to 37 dBm for 50 MHz bandwidth, while low power devices are limited to a range from 7 dBm for 1 MHz bandwidth to 24 dBm for 50 MHz bandwidth. The second maximum output power is dependent on threshold PSDs. A threshold PSD refers to a maximum allowable power per unit bandwidth, typically measured in dBm per MHz (dBm/MHz) or dBm per RB (dBm/RB). An NE 102 may signal or configure the threshold PSDs at one or more UEs 104 to reduce spectral emissions and ensure regulatory compliance. For example, a threshold PSD may be 21 dBm/MHz for high power devices or 8 dBm/MHz for low power devices. The conducted power limits in Table 1 scale approximately linearly with carrier bandwidth but include a 1 dB offset compared to the theoretical maximum based on the threshold PSD, leading to both the maximum conducted power and threshold PSD being enforced independently to ensure regulatory compliance.

In the wireless communications system 100, the coexistence of both maximum conducted power limits and PSD thresholds creates complexity in power selection for UEs 104 and NEs 102. For example, a UE 104 may determine whether the maximum conducted power limit or the PSD based power limit is more restrictive for a given bandwidth allocation, which can vary dynamically based on resource allocations from an NE 102. For narrow bandwidth transmissions, a threshold PSD may be the lower of the two values, while for wider bandwidth transmissions, the maximum conducted power may become the lower of the two values, preventing the UE 104 from utilizing a full output power capability even when the maximum total output power has not been reached. Having two different maximum output powers (e.g., output power limits) may lead to inefficient power utilization, where the UE 104 either underutilizes available output power or implements complex power selection algorithms that increase computational overhead. Additionally, or alternatively, the UE 104 may not adequately account for dynamic bandwidth allocations and varying channel conditions in the wireless communications system 100, potentially resulting in inefficient output power allocation that degrades link performance, reduces overall system throughput, and impacts the quality of wireless communications between the UE 104 and NE 102.

According to implementations, one or more of the NEs 102 and the UEs 104 are operable to implement various aspects of the techniques described with reference to the present disclosure. For example, a UE 104 receives signaling from an NE 102 that indicates a time-frequency resource allocation associated with an uplink transmission. The UE 104 selects a maximum output power for the uplink transmission that satisfies a threshold PSD for the time-frequency resource allocation. The UE 104 transmits the uplink transmission using a power that is less than or equal to the selected maximum output power. The UE 104 accounting for the threshold PSD when selecting a maximum output power enables more efficient power selection that dynamically adapts to resource allocations, while maintaining regulatory compliance with PSD thresholds, thereby improving power utilization efficiency and reducing computational complexity in power control procedures.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

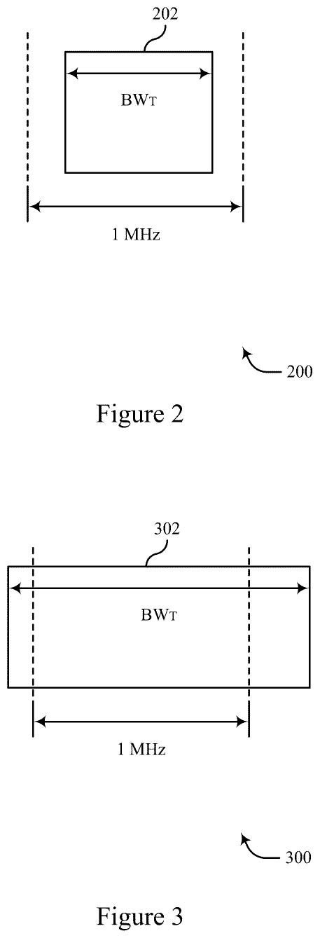

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by a UE and/or an NE, which may be an example of an NE 102 and a UE 104 as described with reference to FIG. 1. The transmission diagram 200 may include a transmission 202 from a UE to an NE, which may be referred to as an uplink transmission.

For a device (e.g., UE or NE) with an output power greater than a threshold value (e.g., 21 dBm), a maximum PSD can be exceeded if the bandwidth of an RB allocation is less than 1 MHz. The transmission bandwidth in MHz, BW_{T}, corresponding to a contiguous RB allocation depends on the number of contiguous RBs, L_{RB}, and the SCS in kHz, and is given by Equation 4:

$${BW}_{T} = \frac{12 * SCS * {L}_{RB}}{1000} . \qquad ( 4 )$$

For the bandwidth, the maximum power that can be transmitted without violating the threshold PSD (e.g., 21 dBm/MHz) is given by Equation 5:

$${P}_{max ( psd )} ( dB ) = max ( 10 {log}_{10} \frac{12 * SCS * {L}_{RB}}{1000} , 0 ) + 21 , \qquad ( 5 )$$

where the value of SCS is in kHz and the subscript max(psd) denotes that the power limit P_{max(psd)}(dB) is due to the PSD threshold. Equation 5 assumes that the measurement bandwidth is equal to 1 MHz, and that the measurement interval is placed such that if BW_{T}≤1 MHz, then the transmission bandwidth of the transmission 202 is within the measurement interval.

FIG. 3 illustrates an example of a transmission diagram 300 in accordance with aspects of the present disclosure. In some examples, the transmission diagram 300 implements or is implemented by aspects of the wireless communications system 100 and the transmission diagram 200. For example, the transmission diagram 300 may be implemented by a UE and/or an NE, which may be an example of an NE 102 and a UE 104 as described with reference to FIG. 1. The transmission diagram may include a transmission 302, which may be an example of an uplink transmission. In some cases, if BW_{T}>1 MHz, then the measurement interval is within the transmission bandwidth, BW_{T}, of the transmission 302.

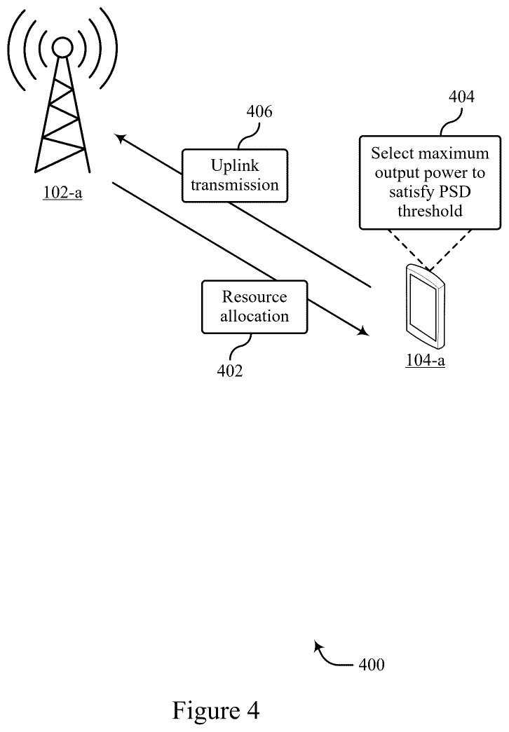

FIG. 4 illustrates an example of a wireless communications system 400 in accordance with aspects of the present disclosure. In some examples, the wireless communications system 400 implements or is implemented by aspects of the wireless communications system 100, the transmission diagram 200, and the transmission diagram 300. For example, the wireless communications system 400 may include an NE 102-a and a UE 104-a, which may be an example of an NE 102 and a UE 104 as described with reference to FIG. 1.

In some examples, the NE 102-a may function as a band manager and may have the capability to signal different PSD thresholds and output power thresholds to the UE 104-a. A band manager is an entity responsible for managing spectrum allocation and coordinating access to frequency bands to prevent interference between different devices and technologies operating within a same spectrum. A spectrum refers to the range of electromagnetic frequencies available for wireless communication, such as the 4940 through 4990 MHz frequency band designated for public safety operations. Although reference is made throughout to the 4940 through 4990 MHz frequency band, the PSD-based output power selection may apply to any frequency band.

The band manager may signal a first maximum PSD for low power devices (e.g., UEs with a power capability below a threshold value, UEs with a threshold PSD of 9 dBm/MHz) and one or more first associated carrier bandwidth dependent output power thresholds for the low power devices, a second maximum PSD for high power devices (e.g., UEs with a power capability above a threshold value, UEs with a threshold PSD of 21 dBm/MHz) and one or more second associated carrier bandwidth dependent output power thresholds for the high power devices, a third maximum PSD different from the first and second maximum PSDs, or an indication that there is no maximum PSD. If there is no maximum PSD, then the UE 104-a may transmit up to a minimum of a maximum output power defined for the power class of the UE 104-a and the carrier bandwidth dependent output power limit. Carrier bandwidth dependent output power limits refer to maximum power limits that vary based on the bandwidth of the carrier frequency being used for transmission, where wider bandwidths may provide for higher total output power, while maintaining the same threshold PSD values. The carrier bandwidth dependent output power thresholds ensure that devices operating with different bandwidth allocations comply with regulatory PSD requirements and also improve power utilization for transmission bandwidths.

In some cases, an NE 102-a may transmit signaling to a UE 104-a that includes a resource allocation 402 to indicate time-frequency resources for one or more transmissions. The resource allocation 402 may schedule or assign one or more time and frequency resources for wireless transmission. The resource allocation 402 may include one or more RBs (e.g., an RB allocation), an SCS, time slots, subframes, symbols, subcarriers, a carrier bandwidth, or carriers allocated for uplink or downlink transmission. An RB allocation indicates one or more RBs for wireless transmission, where an RB is a unit of resource allocation that spans a defined number of subcarriers in frequency and a defined number of symbols in time. The RB allocation may be contiguous or non-contiguous and may vary dynamically based on scheduling decisions by the NE 102-a. The NE 102-a may signal the resource allocation 402 to the UE 104-a through downlink control information (DCI), radio resource control (RRC) signaling, or other control messaging.

At 404, the UE 104-a may select a maximum output power to satisfy a PSD threshold. For example, the UE 104-a may determine an upper bound for the maximum output power utilizing the time-frequency resource allocation received from the NE 102-a. In some cases, the UE 104-a may calculate the upper bound for the maximum output power using the number of allocated RBs, the SCS, and a threshold PSD value, such as 21 dBm per MHz for high power devices or 8 dBm per MHz for low power devices. The UE 104-a may determine the transmission bandwidth using Equation 4 and calculate the maximum allowable power (e.g., the upper bound) using Equation 5. In some cases, the UE 104-a may also determine a lower bound for the maximum output power. The UE 104-a may compare multiple power limitations, including maximum conducted power thresholds (e.g., referred to as a maximum total transmit power) according to a channel bandwidth and PSD-based power limits.

For example, P_{Powerclass} denotes a power class of the UE 104-a, which can be 23 dBm, 26 dBm, 29 dBm, or 31 dBm corresponding to the power classes PC 3, PC 2, PC 1.5, and PC 1, respectively. In order for the UE 104-a to not exceed the threshold PSD (e.g., 21 dBm/MHz for high power devices), the UE configured maximum output power, P_{C,max}, may not exceed the maximum output power P_{max(psd)}(dB) defined in Equation 5. In order to enforce the restriction, the UE 104-a may implement a mandatory maximum power reduction (MMPR), as defined in Equation 6:

$$MMPR = max ( {P}_{Powerclass} - {P}_{max ( psd )} ( dB ) , 0 ) . \qquad ( 6 )$$

The MMPR is a function of both the number of RBs allocated and the SCS in kHz.

The threshold PSD is not sufficient to enforce the limit on the maximum conducted output power of the carrier, as there is a 1 dB difference between a maximum output power to satisfy the threshold PSD and the maximum conducted output power (e.g., maximum total output power). In some cases, P_{FCC,4.9}(CBW) denotes a maximum conducted output power for a carrier bandwidth, as indicated in Table 1. The UE 104-a may determine a configured maximum output power for a single carrier according to Equation 2 and Equation 3. For an RB allocation (e.g., indicated in the resource allocation 402), the UE 104-a may configure a maximum configured output power, P_{CMAX,f,c}, between a lower bound, P_{CMAX_L,f,c}, and an upper bound, P_{CMAX_H,f,c} (e.g., P_{CMAX_L,f,c}≤P_{CMAX,f,c}≤P_{CMAX_H,f,c}), where the upper bound and lower bound are defined according to Equation 7 and Equation 8:

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad ( 7 )$$

$${P}_{CMAX \_ H , f , c} = MIN \{ {P}_{EMAX , c} , {P}_{PowerClass} - Δ {P}_{PowerClass} \} \qquad ( 8 )$$

To enforce a maximum output power at the UE 104-a when there is both a configured maximum output power and a maximum output power resulting from the PSD threshold, both P_{CMAX_L,f,c} and P_{CMAX_H,f,c} may include additional terms. For example, the UE 104-a may determine P_{CMAX_H,f,c}, according to Equation 9:

$${P}_{CMAX \_ H , f , c}^{′} = MIN \{ {P}_{EMAX , c} , {P}_{PowerClass} - Δ {P}_{PowerClass} , {P}_{FCC , 4.9} ( CBW ) , {P}_{PowerClass} - MMPR \} . \qquad ( 9 )$$

In some other examples, the UE 104-a may determine P_{CMAX_H,f,c}, more directly (e.g., and equivalently) without the use of MMPR according to Equation 10:

$${P}_{CMAX \_ H , f , c}^{′} = MIN \{ {P}_{EMAX , c} , {P}_{PowerClass} - Δ {P}_{PowerClass} , {P}_{FCC , 4.9} ( CBW ) , {P}_{max ( psd )} \} . \qquad ( 10 )$$

In some cases, the new P_{CMAX_H,f,c} expression may be lower than the existing P_{CMAX_L,f,c} expression in Equation 2. The UE 104-a may be unable to configure a maximum output power between a lower bound and an upper bound. Thus, the UE 104-a may determine the lower bound, P_{CMAX_L,f,c}, according to one of Equation 11, Equation 12, or Equation 13, which are equivalent. Equation 11 includes the P_{CMAX,f,c} upper bound as an additional term. Equation 12 includes the terms from P′_{CMAX_H,f,c} in Equation 9. Equation 13 includes the terms from P′_{CMAX_H,f,c} in Equation 10.

$${P}_{CMAX \_ L , f , c}^{′} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) , {P}_{CMAX \_ H , f , c}^{′} \} \qquad ( 11 )$$

$${P}_{CMAX \_ L , f , c}^{′} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) , {P}_{FCC , 4.9} ( CBW ) , {P}_{PowerClass} - MMPR \} \qquad ( 12 )$$

$${P}_{CMAX \_ L , f , c}^{′} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) , {P}_{FCC , 4.9} ( CBW ) , {P}_{max ( psd )} \} \qquad ( 13 )$$

The maximum conducted power values, P_{FCC,4.9}(CBW), defined in Table 1 are not aligned with the power classes (e.g., PC 3 (23 dBm), PC 2 (26 dBm), PC 1.5 (29 dBm), and PC 1 (31 dBm)). Since maximum power reduction (MPR) and additional maximum power reduction (A-MPR) values may increase with power class (e.g., and may be explicitly defined for the power classes), the UE 104-a may use the power class with a lowest power that exceeds P_{FCC,4.9}(CBW) for a channel bandwidth.

The UE 104-a may perform an uplink transmission 406 using a power that is less than or equal to the selected maximum output power. The uplink transmission 406 may include transmitting data, control information, or reference signals to the NE 102-a. In some cases, the uplink transmission 406 may use the time-frequency resources specified in the resource allocation 402, while maintaining the maximum output power selected at 404. The uplink transmission 406 may comply with regulatory requirements by ensuring the transmitted power does not exceed the threshold PSD or maximum conducted power limits. In some cases, the uplink transmission 406 may be a physical uplink shared channel (PUSCH) transmission, physical uplink control channel (PUCCH) transmission, or a reference signal transmission, among other example transmissions.

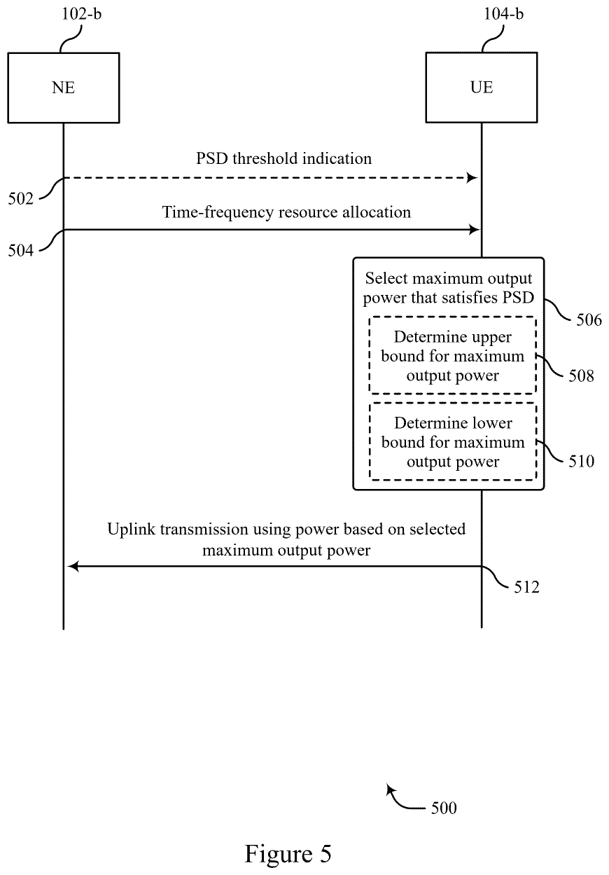

FIG. 5 illustrates an example of a signaling diagram 500 in accordance with aspects of the present disclosure. In some examples, the signaling diagram 500 implements or is implemented by aspects of the wireless communications system 100, the transmission diagram 200, the transmission diagram 300, and the wireless communications system 400. The signaling diagram 500 may implement or be implemented by one or more devices, such as an NE 102-b and a UE 104-b, which may be examples of an NE 102 and a UE 104 as described with reference to FIG. 1. The signaling diagram 500 may illustrate an example of transmit power selection that satisfies a threshold PSD for wireless communications. Alternative examples of the following may be implemented, where some processes are performed in a different order than described or are not performed. In some cases, processes may include additional features not mentioned below, or further processes may be added.

At 502, the NE 102-b transmits signaling (e.g., additional signaling prior to the signaling at 504) that indicates one or more threshold PSDs (e.g., a maximum PSD, a PSD limit) to the UE 104-b. The signaling may include a first maximum PSD and one or more first associated carrier bandwidth dependent output power thresholds for low power devices (e.g., first UEs with a first power capability below a first threshold value). A power capability refers to a maximum power that a device is capable of outputting, which may correspond to a power class designation. Additionally, or alternatively, the signaling may include a second maximum PSD and one or more second associated carrier bandwidth dependent transmit power thresholds for high power devices (e.g., second UEs with a second power capability above a second threshold value). Additionally, or alternatively, the signaling may include a third maximum PSD different from the first and second maximum PSD values for the low power device and the high power device. Additionally, or alternatively, the signaling may include an indication that there is no maximum PSD. For example, the threshold PSD may be 21 dBm per MHz for high power devices or 8 dBm per MHz for low power devices (e.g., as defined for the 4940 through 4990 MHz public safety band). The signaling may indicate different threshold PSDs or PSD limits based on the UE power class, such as PC 3 (23 dBm), PC 2 (26 dBm), PC 1.5 (29 dBm), or PC 1 (31 dBm). In some cases, the threshold PSD may be configured via RRC signaling or system information blocks (SIBs). In some other cases, the threshold PSD may be predefined (e.g., preconfigured, configured) for different frequency bands or may be dynamically adjusted based on interference conditions or regulatory criterion.

At 504, the NE 102-b transmits signaling that indicates a time-frequency resource allocation for an uplink transmission to the UE 104-b. The time-frequency resource allocation may indicate one or more RBs, an SCS, and/or bandwidth parameters that the UE 104-b may use for the uplink transmission. For example, the resource allocation may include a contiguous allocation of RBs with a defined SCS, such as 15 kHz, 30 kHz, 60 kHz, or 120 kHz. In some cases, the UE 104-b may calculate a transmission bandwidth according to Equation 4. The NE 102-b may transmit the signaling via DCI in a physical downlink control channel (PDCCH) or through higher layer signaling, such as RRC signaling. In some cases, the resource allocation may be semi-persistent or configured through scheduling request procedures. The resource allocation may also indicate the carrier bandwidth, which determines applicable power limits from regulatory tables.

At 506, the UE 104-b selects a maximum output power (e.g., a configured maximum output power) for the uplink transmission. The maximum output power satisfies the threshold PSD for the time-frequency resource allocation. The UE 104-b may determine the maximum output power to be within an upper bound and a lower bound, defined by P′_{CMAX_H,f,c} and P′_{CMAX_L,f,c}, respectively, that account for the threshold PSD. For example, the UE 104-b may calculate an MMPR and may use the MMPR to calculate the upper and lower bounds for the maximum output power, as described with reference to FIG. 4. In some other examples, the UE 104-b may calculate the upper and lower bounds for the maximum output power without first calculating the MMPR, which is also described with reference to FIG. 4. The UE may also consider path loss measurements, power control commands from the NE 102-b, and other factors (e.g., maximum power reduction and additional maximum power reduction) when selecting the maximum output power.

In some cases, at 508, the UE 104-b determines the upper bound for the maximum output power. For example, the UE 104-b determines the upper bound for the maximum output power, P′_{CMAX_H,f,c}, utilizing an RB allocation, an SCS, a bandwidth of a carrier associated with the uplink transmission, or a maximum output power for the uplink transmission. To satisfy the PSD associated with the time-frequency resource allocation, the maximum output power is less than the upper bound for the maximum output power. The UE 104-b may determine the upper bound for the maximum output power associated with the uplink transmission based on a difference between a maximum output power capability of a power class associated with the UE and an additional maximum output power associated with the threshold PSD.

In some cases, at 510, the UE 104-b determines the lower bound for the maximum output power. For example, the UE 104-b determines the lower bound for the maximum output power, P′_{CMAX_L,f,c}, utilizing a maximum power associated with the threshold PSD. To satisfy the PSD associated with the time-frequency resource allocation, the maximum output power is greater than the lower bound for the maximum output power. The UE 104-b may determine the maximum output power associated with the uplink transmission according to one or more of a bandwidth of a carrier associated with the uplink transmission or a difference between a maximum output power capability of a power class associated with the UE and an additional maximum output power that satisfies the threshold PSD. The UE 104-b may calculate the lower bound for the maximum output power to ensure the maximum output power does not exceed the upper bound according to one of Equation 11, Equation 12, or Equation 13, or by setting the lower bound to be no greater than the upper bound. The lower bound of the maximum output power calculation may also account for power reduction factors, such as MPR, A-MPR, delta tolerances for carrier aggregation (ΔT_{IB,c}), duplex filter effects (ΔT_{C,c}), and SRS transmission effects (ΔT_{RxSRS}).

At 512, the UE 104-b transmits the uplink transmission to the NE 102-b using a power that is based on the maximum output power (e.g., less than or equal to the maximum output power). For example, the power is less than the maximum output power, P_{CMAX,f,c}, where P_{CMAX,f,c} is based on the threshold PSD and the time-frequency resource allocation parameters. The uplink transmission may be a PUSCH transmission, PUCCH transmission, or a reference signal transmission (e.g., an SRS). The UE 104-b selects a power for the uplink transmission that does not exceed the regulatory limits defined for the channel bandwidth and for which the PSD remains within defined limits (e.g., 21 dBm/MHz for high power devices or 8 dBm/MHz for low power devices).

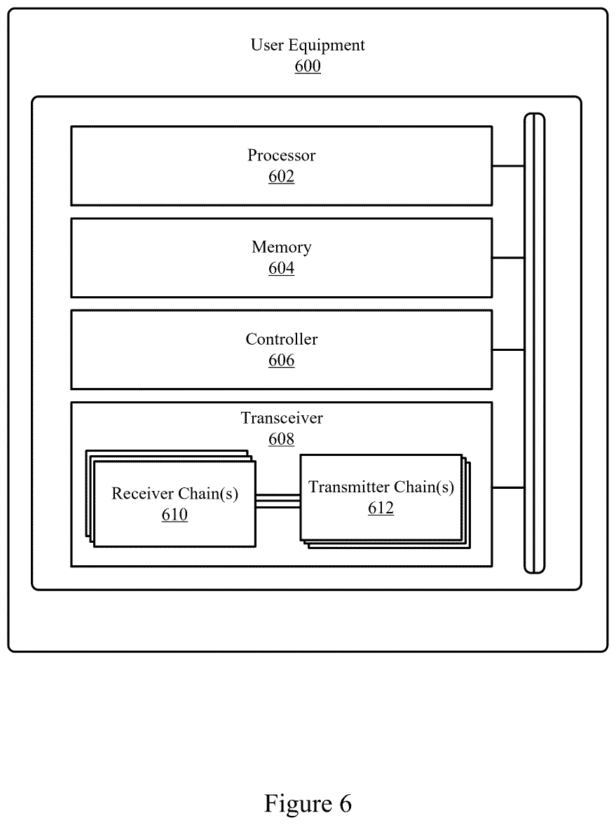

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving signaling that indicates a time-frequency resource allocation associated with an uplink transmission, selecting a maximum output power for the uplink transmission, where the maximum output power satisfies a threshold PSD associated with the time-frequency resource allocation, and transmitting the uplink transmission using a power that is based at least in part on the maximum output power.

Additionally, to select the maximum output power, the UE 600 may be configured or operable to support any one or combination of determining an upper bound for the maximum output power, where the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. To satisfy the PSD associated with the time-frequency resource allocation, the UE 600 may be configured or operable to support the maximum output power is less than the upper bound. Additionally, or alternatively, the UE 600 may be configured or operable to support determining the maximum output power based on a difference between a maximum output power capability of a power class associated with the UE and an additional maximum output power associated with the threshold PSD.

Additionally, or alternatively, to select the maximum output power, the UE 600 may be configured or operable to support determining a lower bound for the maximum output power. To satisfy the PSD associated with the time-frequency resource allocation, the UE 600 may be configured or operable to support the maximum output power is greater than the lower bound. Additionally, or alternatively, the UE 600 may be configured or operable to support determining the maximum output power based on one or more of a bandwidth of a carrier associated with the uplink transmission or a difference between a maximum output power capability of a power class associated with the UE and an additional maximum output power associated with the threshold PSD. Additionally, or alternatively, the UE 600 may be configured or operable to support receiving additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD and the second maximum PSD (e.g., for low power devices and high power devices, respectively), or an indication that there is no maximum PSD.

Additionally, or alternatively, the UE 600 may support at least one memory (e.g., the memory 604) and at least one processor (e.g., the processor 602) coupled with the at least one memory and configured or operable to cause the UE to receive signaling that indicates a time-frequency resource allocation associated with an uplink transmission, select a maximum output power for the uplink transmission, where the maximum output power satisfies a threshold PSD associated with the time-frequency resource allocation, and transmit the uplink transmission using a power that is based on the maximum output power.

Additionally, to select the maximum output power, the UE 600 may be configured or operable to support any one or combination of to determine an upper bound for the maximum output power, where the upper bound is based on one or more of an RB allocation associated with the time-frequency resource allocation, an SCS associated with the time-frequency resource allocation, a bandwidth of a carrier associated with the uplink transmission, or a maximum power associated with threshold PSD. Additionally, or alternatively, to satisfy the PSD associated with the time-frequency resource allocation, the UE 600 may be configured or operable to support the maximum output power is less than the upper bound. Additionally, or alternatively, the UE 600 may be configured or operable to support to determine the maximum output power based on a difference between a maximum output power capability of a power class associated with the UE and an additional maximum output power associated with the threshold PSD.

Additionally, or alternatively, to select the maximum output power, the UE 600 may be configured or operable to support to determine a lower bound for the maximum output power. Additionally, or alternatively, to satisfy the PSD associated with the time-frequency resource allocation, the UE 600 may be configured or operable to support the maximum output power is greater than the lower bound. Additionally, or alternatively, the UE 600 may be configured or operable to support to determine the maximum output power based on one or more of a bandwidth of a carrier associated with the uplink transmission or a difference between a maximum output power capability of a power class associated with the UE and an additional maximum output power associated with the threshold PSD. Additionally, or alternatively, the UE 600 may be configured or operable to support to receive additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD and the second maximum PSD (e.g., for the low power device and the high power device, respectively), or an indication that there is no maximum PSD.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

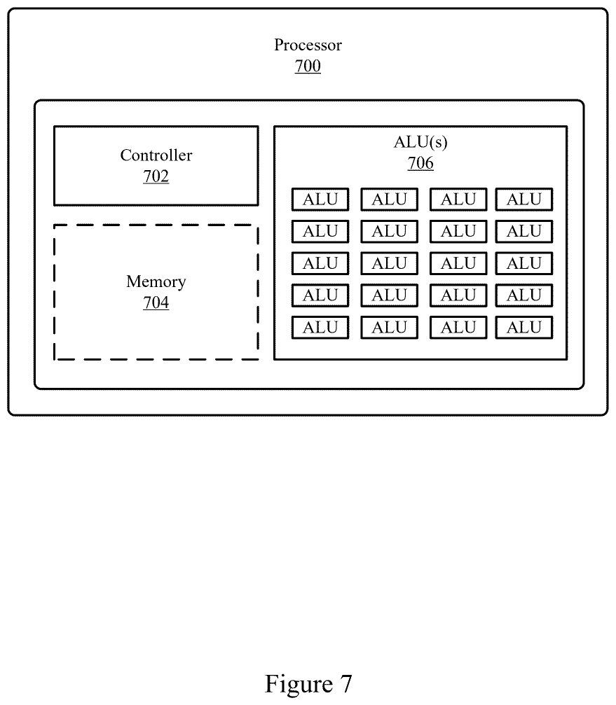

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may be configured to or operable to support at least one controller (e.g., the controller 702) coupled with at least one memory (e.g., the memory 704) and configured to cause the processor to receive signaling that indicates a time-frequency resource allocation associated with an uplink transmission, select a maximum output power for the uplink transmission, where the maximum output power satisfies a threshold PSD associated with the time-frequency resource allocation, and transmit the uplink transmission using a power that is based on the maximum output power.

Additionally, the processor 700 may be configured to or operable to support any one or combination of to select the maximum output power, determining an upper bound for the maximum output power, where the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. Additionally, or alternatively, to satisfy the threshold PSD associated with the time-frequency resource allocation, the processor 700 may be configured or operable to support the maximum output power is less than the upper bound. Additionally, or alternatively, the processor 700 may be configured or operable to support to determine the maximum output power based on a difference between a maximum output power capability of a power class associated with the UE and an additional maximum output power associated with the threshold PSD.

Additionally, or alternatively, to select the maximum output power, the processor 700 may be configured to support to determine a lower bound for the maximum output power. Additionally, or alternatively, to satisfy the threshold PSD associated with the time-frequency resource allocation, the processor 700 may be configured to support the maximum output power is greater than the lower bound. Additionally, or alternatively, the processor 700 may be configured to support to determine the maximum output power associated with the uplink transmission based on one or more of a bandwidth of a carrier associated with the uplink transmission or a difference between a maximum output power capability of a power class associated with the UE and an additional maximum output power associated with the threshold PSD. Additionally, or alternatively, the processor 700 may be configured to support to receive additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD and the second maximum PSD (e.g., for the low power device and the high power device, respectively), or an indication that there is no maximum PSD.

The processor 700 may be configured to or operable to support at least one controller (e.g., the controller 702) coupled with at least one memory (e.g., the memory 704) and configured to cause the processor to transmit signaling that indicates a time-frequency resource allocation associated with an uplink transmission, where the uplink transmission is associated with a maximum output power that satisfies a threshold PSD associated with the time-frequency resource allocation and receive the uplink transmission associated with a power that is based on the maximum output power.

Additionally, the processor 700 may be configured to or operable to support any one or combination of the maximum output power is less than an upper bound for the maximum output power, and where the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. Additionally, or alternatively, the processor 700 may be configured to support the maximum output power is based on a difference between a maximum output power capability of a power class associated with a UE and an additional maximum output power associated with the threshold PSD.

Additionally, or alternatively, the processor 700 may be configured to support the maximum output power is greater than a lower bound for the maximum output power. Additionally, or alternatively, the processor 700 may be configured to support the maximum output power is based on one or more of a bandwidth of a carrier associated with the uplink transmission or a difference between a maximum output power capability of a power class associated with a UE and an additional maximum output power associated with the threshold PSD. Additionally, or alternatively, the processor 700 may be configured to support to transmit additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD and the second maximum PSD, or an indication that there is no maximum PSD.

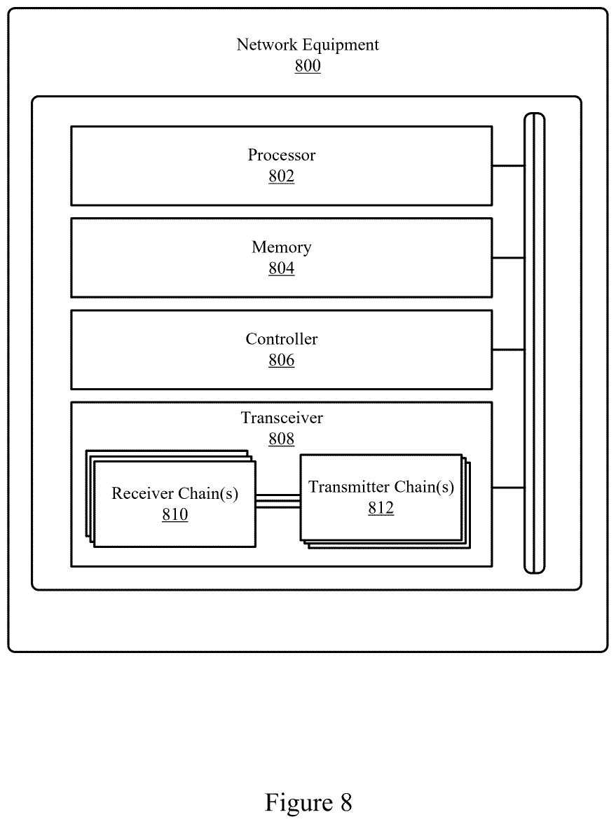

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting signaling that indicates a time-frequency resource allocation associated with an uplink transmission, where the uplink transmission is associated with a maximum output power that satisfies a threshold PSD associated with the time-frequency resource allocation and receiving the uplink transmission associated with a power that is based on the maximum output power.

Additionally, the NE 800 may be configured or operable to support any one or combination of the maximum output power is less than an upper bound for the maximum output power, and where the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. Additionally, or alternatively, the NE 800 may be configured or operable to support the maximum output power is based on a difference between a maximum output power capability of a power class associated with a UE and an additional maximum output power associated with the threshold PSD.

Additionally, or alternatively, the NE 800 may be configured or operable to support the maximum output power is greater than a lower bound for the maximum output power. Additionally, or alternatively, the NE 800 may be configured or operable to support the maximum output power is based on one or more of a bandwidth of a carrier associated with the uplink transmission or a difference between a maximum output power capability of a power class associated with a UE and an additional maximum output power associated with the threshold PSD. Additionally, or alternatively, the NE 800 may be configured or operable to support transmitting additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD and the second maximum PSD (e.g., for the low power devices and the high power devices, respectively), or an indication that there is no maximum PSD.

Additionally, or alternatively, the NE 800 may support at least one memory (e.g., the memory 804) and at least one processor (e.g., the processor 802) coupled with the at least one memory and configured to cause the NE to transmit signaling that indicates a time-frequency resource allocation associated with an uplink transmission, where the uplink transmission is associated with a maximum output power that satisfies a threshold PSD associated with the time-frequency resource allocation and receive the uplink transmission associated with a power that is based on the maximum output power.

Additionally, the NE 800 may be configured or operable to support any one or combination of the maximum output power is less than an upper bound for the maximum output power, and where the upper bound is based on one or more of an RB allocation associated with the time-frequency resource allocation, an SCS associated with the time-frequency resource allocation, a bandwidth of a carrier associated with the uplink transmission, or a maximum power associated with the threshold PSD. Additionally, or alternatively, the NE 800 may be configured or operable to support the maximum output power is based on a difference between a maximum output power capability of a power class associated with a UE and an additional maximum output power associated with the threshold PSD.

Additionally, or alternatively, the NE 800 may be configured or operable to support the maximum output power is greater than a lower bound for the maximum output power. Additionally, or alternatively, the NE 800 may be configured or operable to support the maximum output power is based on one or more of a bandwidth of a carrier associated with the uplink transmission or a difference between a maximum output power capability of a power class associated with a UE and an additional maximum output power associated with the threshold PSD. Additionally, or alternatively, the NE 800 may be configured or operable to support to transmit additional signaling that indicates the threshold PSD, where the additional signaling includes a first maximum PSD and one or more first associated carrier bandwidth dependent transmit power thresholds for first UEs with a first power capability below a first threshold value, a second maximum PSD and one or more second associated carrier bandwidth dependent transmit power thresholds for second UEs with a second power capability above a second threshold value, a third maximum PSD different from the first maximum PSD value and the second maximum PSD value, or an indication that there is no maximum PSD.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

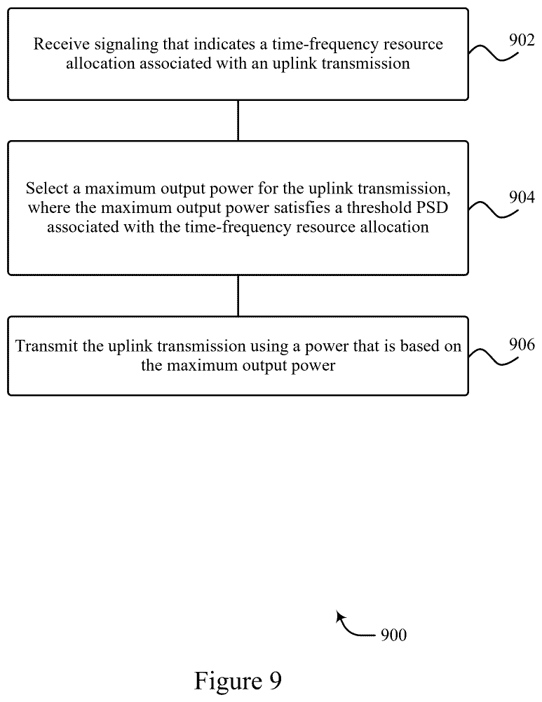

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving signaling that indicates a time-frequency resource allocation associated with an uplink transmission. The operations of 902 may be performed in accordance with examples as described herein. In some implementations, aspects of the operations of 902 may be performed by a UE as described with reference to FIG. 6.

At 904, the method may include selecting a maximum output power for the uplink transmission, where the maximum output power satisfies a threshold PSD associated with the time-frequency resource allocation. The operations of 904 may be performed in accordance with examples as described herein. In some implementations, aspects of the operations of 904 may be performed by a UE as described with reference to FIG. 6.

At 906, the method may include transmitting the uplink transmission using a power that is based on the maximum output power. The operations of 906 may be performed in accordance with examples as described herein. In some implementations, aspects of the operations of 906 may be performed a UE as described with reference to FIG. 6.

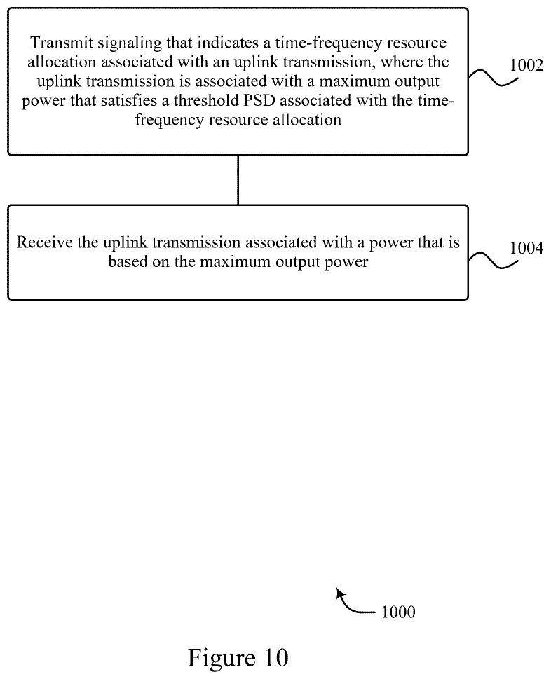

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting signaling that indicates a time-frequency resource allocation associated with an uplink transmission, where the uplink transmission is associated with a maximum output power that satisfies a threshold PSD associated with the time-frequency resource allocation. The operations of 1002 may be performed in accordance with examples as described herein. In some implementations, aspects of the operations of 1002 may be performed by an NE as described with reference to FIG. 8.

At 1004, the method may include receiving the uplink transmission associated with a power that is based on the maximum output power. The operations of 1004 may be performed in accordance with examples as described herein. In some implementations, aspects of the operations of 1004 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a time-frequency resource allocation associated with an uplink transmission;
select a maximum output power for the uplink transmission, wherein the maximum output power satisfies a threshold power spectral density (PSD) associated with the time-frequency resource allocation; and
transmit the uplink transmission using a power that is based at least in part on the maximum output power.

2. The UE of claim 1, wherein to select the maximum output power, the at least one processor is operable to cause the UE to determine an upper bound for the maximum output power, wherein the upper bound is based at least in part on one or more of a resource block allocation associated with the time-frequency resource allocation, a subcarrier spacing (SCS) associated with the time-frequency resource allocation, a bandwidth of a carrier associated with the uplink transmission, or a maximum power associated with the threshold PSD.

3. The UE of claim 2, wherein to satisfy the threshold PSD associated with the time-frequency resource allocation, the maximum output power is less than the upper bound.

4. The UE of claim 2, wherein the at least one processor is further operable to cause the UE to determine the maximum output power based at least in part on a difference between a maximum output power capability of a power class associated with the UE and an additional maximum output power associated with the threshold PSD.

5. The UE of claim 1, wherein to select the maximum output power, the at least one processor is operable to cause the UE to determine a lower bound for the maximum output power.

6. The UE of claim 5, wherein the at least one processor is further operable to cause the UE to determine the maximum output power based at least in part on one or more of a bandwidth of a carrier associated with the uplink transmission or a difference between a maximum output power capability of a power class associated with the UE and an additional maximum output power associated with the threshold PSD.

7. The UE of claim 5, wherein to satisfy the threshold PSD associated with the time-frequency resource allocation, the maximum output power is greater than the lower bound.

8. The UE of claim 1, wherein the at least one processor is further operable to cause the UE to receive additional signaling that indicates the threshold PSD, wherein the additional signaling comprises:
a first maximum PSD and one or more first associated carrier bandwidth dependent transmit power thresholds for first UEs with a first power capability below a first threshold value;
a second maximum PSD and one or more second associated carrier bandwidth dependent transmit power thresholds for second UEs with a second power capability above a second threshold value;
a third maximum PSD different from the first maximum PSD and the second maximum PSD; or
an indication that there is no maximum PSD.

9. A method performed by a user equipment (UE), the method comprising:
receiving signaling that indicates a time-frequency resource allocation associated with an uplink transmission;
selecting a maximum output power for the uplink transmission, wherein the maximum output power satisfies a threshold power spectral density (PSD) associated with the time-frequency resource allocation; and
transmitting the uplink transmission using a power that is based at least in part on the maximum output power.

10. The method of claim 9, wherein selecting the maximum output power comprises determining an upper bound for the maximum output power, wherein the upper bound is based at least in part on one or more of a resource block allocation associated with the time-frequency resource allocation, a subcarrier spacing (SCS) associated with the time-frequency resource allocation, a bandwidth of a carrier associated with the uplink transmission, or a maximum power associated with the threshold PSD.

11. The method of claim 9, wherein selecting the maximum output power comprises determining a lower bound for the maximum output power.

12. The method of claim 9, further comprising receiving additional signaling that indicates the threshold PSD, wherein the additional signaling comprises:
a first maximum PSD and one or more first associated carrier bandwidth dependent transmit power thresholds for first UEs with a first power capability below a first threshold value;
a second maximum PSD and one or more second associated carrier bandwidth dependent transmit power thresholds for second UEs with a second power capability above a second threshold value;
a third maximum PSD different from the first maximum PSD and the second maximum PSD; or
an indication that there is no maximum PSD.

13. A network equipment (NE) for wireless communication, comprising:
at least one memory; and
at least one processor coupled with the at least one memory and operable to cause the NE to:
transmit signaling that indicates a time-frequency resource allocation associated with an uplink transmission, wherein the uplink transmission is associated with a maximum output power that satisfies a threshold power spectral density (PSD) associated with the time-frequency resource allocation; and
receive the uplink transmission associated with a power that is based at least in part on the maximum output power.

14. The NE of claim 13, wherein the maximum output power is less than an upper bound for the maximum output power, and wherein the upper bound is based at least in part on one or more of a resource block allocation associated with the time-frequency resource allocation, a subcarrier spacing (SCS) associated with the time-frequency resource allocation, a bandwidth of a carrier associated with the uplink transmission, or a maximum power associated with the threshold PSD.

15. The NE of claim 14, wherein the maximum output power is based at least in part on a difference between a maximum output power capability of a power class associated with a user equipment (UE) and an additional maximum output power associated with the threshold PSD.

16. The NE of claim 13, wherein the maximum output power is greater than a lower bound for the maximum output power.

17. The NE of claim 16, wherein the maximum output power is based at least in part on one or more of a bandwidth of a carrier associated with the uplink transmission or a difference between a maximum output power capability of a power class associated with a user equipment (UE) and an additional maximum output power associated with the threshold PSD.

18. The NE of claim 13, wherein the at least one processor is further operable to cause the NE to transmit additional signaling that indicates the threshold PSD, wherein the additional signaling comprises:
a first maximum PSD and one or more first associated carrier bandwidth dependent transmit power thresholds for first UEs with a first power capability below a first threshold value;
a second maximum PSD and one or more second associated carrier bandwidth dependent transmit power thresholds for second UEs with a second power capability above a second threshold value;
a third maximum PSD different from the first maximum PSD and the second maximum PSD; or
an indication that there is no maximum PSD.

19. A method performed by a network equipment (NE), the method comprising:
transmitting signaling that indicates a time-frequency resource allocation associated with an uplink transmission, wherein the uplink transmission is associated with a maximum output power that satisfies a threshold power spectral density (PSD) associated with the time-frequency resource allocation; and
receiving the uplink transmission associated with a power that is based at least in part on the maximum output power.

20. The method of claim 19, further comprising transmitting additional signaling that indicates the threshold PSD, wherein the additional signaling comprises:
a first maximum PSD and one or more first associated carrier bandwidth dependent transmit power thresholds for first UEs with a first power capability below a first threshold value;
a second maximum PSD and one or more second associated carrier bandwidth dependent transmit power thresholds for second UEs with a second power capability above a second threshold value;
a third maximum PSD different from the first maximum PSD and the second maximum PSD; or
an indication that there is no maximum PSD.
